(19) United States
(12) Patent Application Publication
(10) Pub. No.: US 2026/0268177 A1
(43) Pub. Date: Sep. 10, 2026

(54) MINERAL PROSPECTING PREDICTION METHOD BASED ON MULTI-AGENT TECHNOLOGY

(71) Applicant: COMPREHENSIVE NATURAL RESOURCES SURVEY CENTER, CHINA GEOLOGICAL SURVEY., BEIJING (CN)

(72) Inventors: GUOXI SONG, BEIJING (CN); BIN WANG, BEIJING (CN); ZHENJI GAO, BEIJING (CN); ZHAOLIANG LI, BEIJING (CN); YUE SONG, BEIJING (CN); LAN WANG, BEIJING (CN)

(21) Appl. No.: 19/454,862

(22) Filed: Jan. 21, 2026

(30) Foreign Application Priority Data
Mar. 10, 2025 (CN) 202510273752.3

(51) Int. Cl. G06N 5/04; G06F 16/3332; G06F 16/901; G06F 40/284; G06F 40/289; G06F 40/35; G06N 3/0442; G06N 3/092; G06N 7/01

(52) U.S. Cl. CPC G06N 5/04; G06F 16/3334; G06F 16/9024; G06F 40/284; G06F 40/289; G06F 40/35; G06N 3/0442; G06N 3/092; G06N 7/01

(57) ABSTRACT

The present disclosure discloses a mineral prospecting prediction method based on multi-agent technology, including: S 11: performing keyword extraction on a mineral-related problem input by a user; S12: establishing a vector database of mineral knowledge texts and a graph database of a mineral knowledge graph, and optimizing the extracted keywords to generate a prompt; S13: constructing a mineral prospecting large model to reason about the prompt, expanding the prompt to obtain a complete statement that professionally reformulates the user's problem; S14: performing multi-task decomposition on the complete statement to obtain a plurality of subtasks, and scheduling the plurality of subtasks to corresponding agents via the graph database of the mineral knowledge graph for stepwise prediction; S15: integrating and feeding back the prediction results of the agents to the user.

### TECHNICAL FIELD

The present disclosure relates to the technical field of mineral resource prediction, and more particularly to a mineral prospecting prediction method based on multi-agent technology.

### BACKGROUND

In the field of geology, traditional geological analysis often relies on manual observation of limited samples and empirical judgment, which is inefficient and may be one- sided. Artificial intelligence, with its powerful algorithms, can rapidly analyze massive geological data, uncover hidden patterns and features, and has promoted the vigorous development of artificial intelligence in mathematical geoscience and mineral exploration, providing more scientific and efficient technical means for prospecting. The application of new-generation information technologies such as big data, machine learning, and cloud computing to mineral exploration and prediction can improve the efficiency of prospecting. At home and abroad, emerging trends in mineral resource exploration have become clear. In future mineral resource exploration and prediction, greater emphasis will be placed on integrating data resources across different spatiotemporal dimensions and leveraging powerful computing capabilities and advanced model algorithms to mine more valuable prospecting information.

With years of mineral exploitation and the continuously increasing difficulty of exploration, the detection of mineral resources faces many challenges, such as the detection of deep mineral resources, the discovery of concealed ore deposits, and metallogenic prediction under complex geological conditions. Developing mineral prospecting prediction methods based on technologies such as RAG (Retrieval-Augmented Generation), knowledge graphs, large models, agents, big data, spatial computing, and scientific analysis has become a key direction. Advancing new quality productive forces in AI-based prospecting is of vital significance for addressing major scientific and technical challenges in resource evaluation and prediction.

### SUMMARY

In view of this, it is an object of the present disclosure to provide a mineral prospecting prediction method based on multi-agent technology to improve the efficiency and accuracy of mineral prospecting prediction through intelligent means.

To achieve the above object, the present disclosure provides a mineral prospecting prediction method based on multi-agent technology, including:

S11. performing keyword extraction on a mineral-related problem input by a user;

S12. establishing a vector database of mineral knowledge texts and a graph database of a mineral knowledge graph, and optimizing the extracted keywords to generate a prompt;

S13. constructing a mineral prospecting large model to reason about the prompt, expanding the prompt to obtain a complete statement that professionally reformulates the user's problem;

S14. performing multi-task decomposition on the complete statement to obtain a plurality of subtasks, and scheduling the plurality of subtasks to corresponding agents via the graph database of the mineral knowledge graph for stepwise prediction;

S15. integrating and feeding back the prediction results of the agents to the user.

Further, step S11 includes:

S21. parsing the mineral-related problem using NLP techniques and matching and classifying the parsed problem with nodes and relations in the mineral knowledge graph;

S22. automatically generating keywords corresponding to the mineral-related problem by combining the mineral knowledge graph and historical question data.

Further, establishing the vector database of mineral knowledge texts and the graph database of the mineral knowledge graph of step S12 specifically includes:

S31. collecting and storing documents in real time, including prospecting prediction papers, monographs, and geological reports;

S32. performing unified format conversion and preprocessing on the stored document data;

S33. segmenting the preprocessed document data into chunks of a preset length, inputting the chunks into an embedding model to convert the document data into vectors, and constructing the vector database of mineral knowledge texts;

S34. performing knowledge extraction, relation extraction, and attribute extraction on the chunked document data, fusing the extracted data, and constructing the graph database of the mineral knowledge graph.

Further, optimizing the extracted keywords to generate a prompt of step S12 specifically includes:

S41. constructing a graph database query language and query statements, performing syntax checking on the keywords, and determining a specific graph structure and information the user wants to query;

S42. formulating a specific query execution plan based on the analysis of the graph structure and the query requirements, and determining the visitation order of nodes and relations;

S43. traversing the nodes and relations, organizing the qualified nodes, relations, and associated attribute information, and generating the prompt.

Further, constructing a mineral prospecting large model of step S13 specifically includes:

S51. cleaning the stored data, selecting a tokenization tool to perform tokenization on the cleaned data, expanding a vocabulary, and increasing sample diversity via text data augmentation techniques;

S52. dividing the processed data into a training set, a validation set, and a test set at a preset ratio, training, tuning, and evaluating a pre-trained mineral prospecting large model to obtain the mineral prospecting large model;

S53. adjusting dimensions of an embedding layer and an output layer of the mineral prospecting large model according to the expanded vocabulary to maintain consistency with a size of the expanded vocabulary;

S54. performing supervised fine-tuning, incremental training, and mineral-prospecting instruction learning on the mineral prospecting large model.

Further, step S14 further includes:

performing semantic understanding on the complete statement using natural language processing techniques to extract key information and perform task decomposition, while establishing, for each agent, a semantic label library of algorithms, and intelligently selecting and orchestrating algorithms based on a matching degree between task semantics and algorithm semantic labels to match tasks with algorithms;

constructing a dynamic Bayesian network with the geological characteristics of the prospecting area, data quality, and computing resources as nodes, and dependencies among the factors as edges, and dynamically adjusting algorithm selection and execution order by updating node information and edge weights in real time;

exploring an optimal collaboration policy among agents via reinforcement learning, maintaining real-time communication among agents, and adjusting the collaboration policy among agents according to a global reward signal;

recording the execution process and results of the algorithms, and providing a reward to agents corresponding to algorithms whose collaboration degree reaches a preset threshold during collaboration;

monitoring, in real time, the computing resource usage of each agent, and dynamically adjusting the execution order of algorithms and allocating resources to the algorithms according to remaining resources and the resource demands of the algorithms.

Further, performing semantic understanding on the complete statement using natural language processing techniques to extract key information specifically includes:

S61. recognizing words in the complete statement and semantic roles among the words, and analyzing dependency relations among the words in the complete statement;

S62. capturing sentence structure and sequential information in the complete statement via a BiLSTM to extract contextual semantic features from the complete statement;

S63. extracting key information in the complete statement by combining the dependency relations among words obtained in step S61 and the contextual semantic features extracted in step S62 with the graph database of the mineral knowledge graph.

Further, exploring an optimal collaboration policy among agents via reinforcement learning specifically includes:

S71. defining a local state of each agent, a global environment, and a global reward signal;

S72. enabling all agents to interact with observations of their local states and the global environment to obtain, for the current agent, observations that incorporate observations from other agents;

S73. processing observations of different dimensions via semantic embedding to convert the observations into Q (Query), K (Key), and V (Value) sequences, learning features of the Q, K, and V sequences and their interrelationships via a self-attention mechanism, and fusing the sequences via a Transformer architecture to generate a globally optimized hidden state;

S74. generating, via a multilayer perceptron (MLP), a local Q-value for each agent based on the fused hidden state, and combining the local Q-values of all agents into a global Q-value via a value decomposition method;

S75. updating a policy network of each agent via a reinforcement learning algorithm using the global Q-value and the global reward signal.

Further, step S15 specifically includes:

integrating the prediction results of the agents and feeding the results back to the user in the form of text, images, GIS maps, three-dimensional models, and document reports.

Compared with the prior art, the beneficial effects of the present disclosure are as follows.

The mineral prospecting prediction method based on multi-agent technology provided by the present disclosure realizes keyword extraction from mineral-related problem through natural language processing technology, innovatively combines a vector database of mineral knowledge texts with a graph database of the mineral knowledge graph, and optimize the extracted keywords to generate a prompt, thereby enhancing knowledge retrieval and augmenting performance, and expanding the prompt by a pretrained mineral prospecting large model to generate complete statements for mineral prospecting problem.

By means of multi-agent technology, intelligent orchestration and scheduling of mineral prospecting prediction algorithms are achieved, integrating the strengths of the mineral prospecting large model and specialized algorithmic tools to elevate the intelligence level of tasks such as data querying, data mining, information extraction, prospecting prediction, target area optimization, and decision support. Prediction results are fed back through a multimodal data structure to satisfy users' diverse requirements for mineral prediction. Compared with conventional prospecting prediction methods that rely predominantly on manual effort and fragmented tools, the present disclosure drives the transition of prospecting prediction from human-driven to intelligent-driven, thereby providing emerging technological support for breakthroughs in mineral exploration.

### BRIEF DESCRIPTION OF DRAWINGS

In order to more clearly illustrate the technical solutions in the embodiments of the present disclosure or in the prior art, the drawings required for describing the embodiments or the prior art will be briefly introduced below. Obviously, the drawings described below are merely embodiments of the present disclosure; for those skilled in the art, without undertaking creative labor, other drawings may also be obtained based on the drawings provided herein.

FIG. 1 is a schematic flow diagram of a mineral prospecting prediction method based on multi-agent technology, provided by an embodiment of the present disclosure.

### DETAILED DESCRIPTION OF EMBODIMENTS

The present disclosure will be further described in detail below with reference to the accompanying drawings and embodiments. It should be understood that the specific embodiments described herein are merely for explaining the present disclosure and are not intended to limit the present disclosure. In addition, for ease of description, the accompanying drawings show only parts related to the present disclosure rather than all the structures.

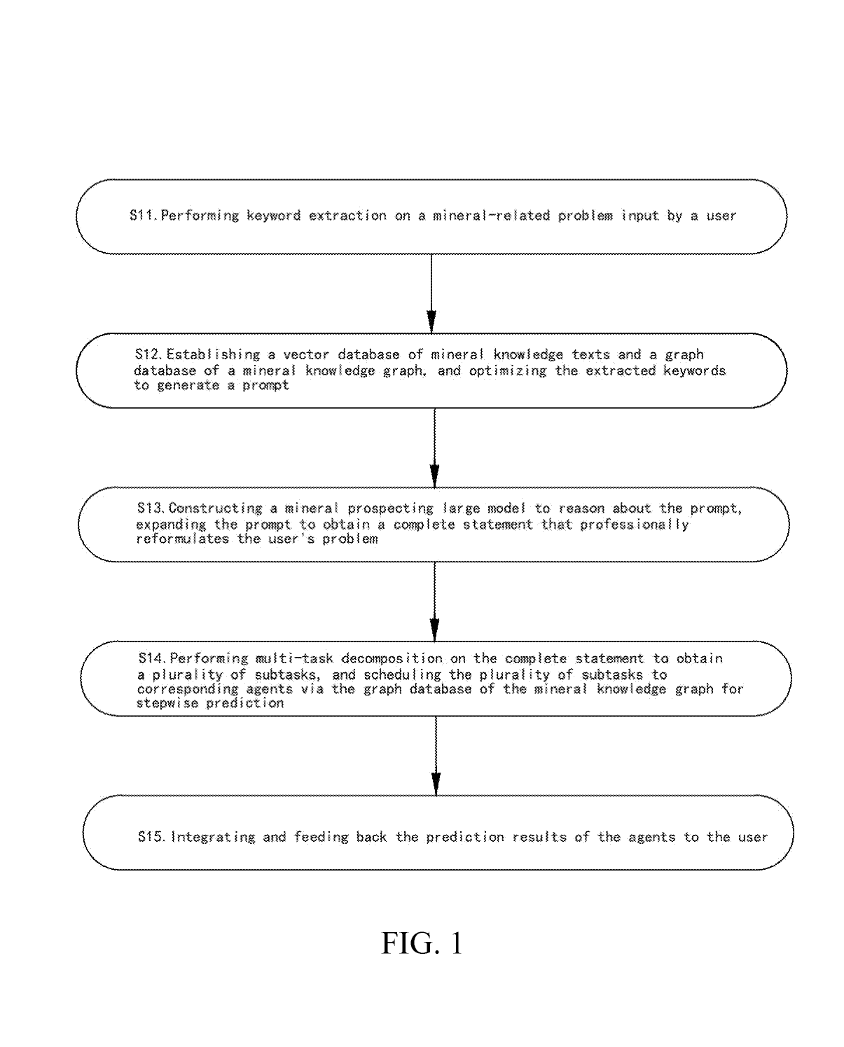

With reference to FIG. 1, the present embodiment provides a mineral prospecting prediction method based on multi-agent technology. The mineral prospecting prediction method based on multi-agent technology includes following steps.

S11. performing keyword extraction on a mineral-related problem input by a user. To ensure data security and privacy, a security mechanism and an access control system are introduced. Technologies such as identity authentication, access control, and data encryption are employed to ensure that only authorized users can proceed with subsequent prospecting prediction processes. Meanwhile, access records are audited in detail, and user behavior is tracked to promptly detect and address potential security issues, thereby providing reliable security assurance for prospecting prediction work.

Throughout the operation of the mineral prospecting prediction method, keyword extraction is performed on various professional mineral prospecting prediction-related problems raised by users. For example, mineral-related problems include, but are not limited to: viewing a prediction work area database, analyzing and classifying mineral prediction types, determining mineral prediction method types, and summarizing metallogenic geological backgrounds and compiling maps. Extracted keywords include, but are not limited to: mineral prediction, database, prediction type, and prediction method.

Step S11 specifically includes: S21. parsing the mineral-related problem using natural language processing techniques and matching and classifying the parsed problem with nodes and relations in the mineral knowledge graph; S22. automatically generating keywords corresponding to the mineral-related problem by combining the mineral knowledge graph and historical question data.

In the present embodiment, to extract keywords from mineral-related problems, a professional problem classification and intelligent prompting technology is proposed. First, based on the knowledge graph, mineral-related problems are classified. A mineral knowledge graph in the field of prospecting prediction is innovatively utilized. When a user inputs a problem, natural language processing techniques are used to parse the mineral-related problem and match it with nodes and relations in the mineral knowledge graph, thereby achieving intelligent classification of the mineral-related problem. For example, for the problem "analyze and classify mineral prediction types," the mineral knowledge graph can quickly determine that it belongs to the knowledge category of mineral prediction type classification, providing an accurate classification basis for subsequent problem processing.

Second, an intelligent prompt word generation and optimization technology and a problem intent recognition and inference technology are proposed. Based on partial content input by the user or the general direction of the problem, combined with the mineral knowledge graph and historical question data, relevant keywords are automatically generated and dynamically recommended as options for the front-end user. For example, when the user inputs "view prediction," the present disclosure can prompt "view prediction work area database" or "view prediction model parameters," improving the efficiency and accuracy of problem input. Meanwhile, the algorithm can continuously optimize the keyword generation strategy based on user feedback and usage habits. Finally, optimized multimodal input support is proposed. In addition to text input, voice input, image input, etc., are supported to provide data support for subsequent prospecting prediction.

S12. establishing a vector database of mineral knowledge texts and a graph database of a mineral knowledge graph, and optimizing the extracted keywords to generate a prompt. Prospecting prediction papers and monographs are used as the knowledge base, and a vector database of mineral knowledge texts and a graph database of a mineral knowledge graph are established. Keyword-based knowledge retrieval enhancement is performed. After traversing the vector database and the graph database, contextual fusion is performed to form high-quality prompts that better conform to prospecting prediction business.

In the present embodiment, a graph structure-enhanced knowledge retrieval and verification technology is first proposed. In the RAG architecture, knowledge is organized and stored using a graph structure, where nodes represent knowledge entities and edges represent relationships between entities. When the large model generates content, knowledge retrieval is performed based on the graph structure, retrieving not only entities related to the problem but also the relationships between these entities. After the retrieval results are returned, the relationship information in the graph is used to verify the retrieved knowledge, ensuring that the knowledge relied upon to generate the content is accurate and interrelated. Second, a graph embedding-based generation constraint technology is proposed. Nodes and edges in the graph structure are embedded into a low-dimensional vector space to obtain a graph embedding representation. During content generation by the large model, the generation process is associated with the graph embedding. By constraining the consistency between the vector representation of the generated content and the graph embedding, it is ensured that the generated content conforms to the knowledge structure and logical relationships contained in the graph. Through graph embedding constraints, the relationships among various concepts in the generated content are kept consistent with the scientific knowledge system represented in the graph.

Third, a multimodal graph fusion-based knowledge enhancement technology is proposed. Multimodal information, including text, images, audio, and spatial data, is combined to construct a multimodal graph. During the RAG process, not only textual knowledge is used for retrieval and generation, but information from other modalities is also fused to enhance the accuracy and completeness of the knowledge. In addition to textual descriptions, spatial data can be combined to more accurately present the regional geological characteristics of the prediction area, the geological characteristics of the mineral resources, and metallogenic laws, thereby reducing the occurrence of hallucinations.

Then, a dynamic graph update and feedback mechanism is proposed. A dynamic graph update mechanism is established to update the vector database and the graph database in real time based on the generation results of the large model, user feedback, and the maintenance and updates of the knowledge base and spatial database. When hallucinations or errors are found in the generated content, the causes are analyzed, and the relevant knowledge in the graph is corrected or supplemented to improve the generation quality of the large model and reduce the occurrence of hallucinations. Finally, a graph attention mechanism-based knowledge focusing technology is proposed. During the RAG process, a graph attention mechanism is introduced to dynamically focus on key knowledge nodes and edges in the graph according to the characteristics of the problem and the needs of the generation process.

In step S12, establishing the vector database of mineral knowledge texts and the graph database of the mineral knowledge graph specifically includes:

S31. collecting and storing documents in real time, including prospecting prediction papers, monographs, and geological reports;

S32. performing unified format conversion and preprocessing on the stored document data;

S33. segmenting the preprocessed document data into chunks of a preset length, inputting the chunks into an embedding model to convert the document data into vectors, and constructing the vector database of mineral knowledge texts;

S34. performing knowledge extraction, relation extraction, and attribute extraction on the chunked document data, fusing the extracted data, and constructing the graph database of the mineral knowledge graph.

In the present embodiment, to establish the vector database of mineral knowledge texts and the graph database of the mineral knowledge graph, documents such as prospecting prediction-related papers, monographs, and geological reports are first stored in the personal user workspace. Then, all document data of the prospecting prediction-related papers, monographs, and geological reports in the personal user workspace is extracted and parsed. The document data is preprocessed, including but not limited to: file parsing, noise elimination, redundancy removal, removal of irrelevant and potentially harmful data, and converting document data in different formats into the formats required for training data (e.g., txt or j son). For PDF files in image format, optical character recognition (OCR) technology in computer vision algorithms is used for parsing. Methods such as document segmentation, special format processing, short sentence removal, paragraph merging, deduplication, removal of semantically meaningless paragraphs, and replacement of in-text citations are used to improve the quality of the document data.

The document data is then segmented into smaller chunks to obtain processed document data. Finally, the processed document data is converted into vector representations, such as by using word embedding techniques to map words, sentences, or documents into high- dimensional vector spaces, enabling machines to understand and process the data and capture semantic information and relationships in the text. For example, a Transformer architecture can be used to perform deep bidirectional encoding of the text to learn richer semantic information and contextual relationships. For the vector database of mineral knowledge texts, retrieval is first performed. Based on keywords, similarity queries and retrieval are performed among document data to select the most relevant document data from the pre-constructed personal user workspace. For example, a hybrid retrieval method (HybridRetrieval) can be used, first using a sparse method to quickly filter candidate document data, and then using a dense method to precisely locate the most relevant document data.

Second, re-ranking is performed. After the initial retrieval, a re-ranking stage is used to improve the relevance of the retrieved document data, ensuring that the most relevant information is displayed at the top of the list. More precise and time-consuming methods are used to effectively re-rank the document data, thereby improving the similarity between the query and the top-ranked document data. Re-ranking prioritizes performance and efficiency and mainly includes two methods: DLMReranking and TILDEReranking

Then, document data re-packaging is performed. The performance of LLM response generation may be affected by the provided document data. After re-ranking, there are currently three main re-packaging methods: "forward," "reverse," and "sides." The "forward" method re-packages the document data in descending order of relevance scores starting from the re-ranking stage. The "reverse" method arranges the document data in ascending order. When relevant information is placed at the beginning or end of the input, the "sides" method can achieve the best performance.

A vector database is a database used to store, manage, and retrieve vector data. In the RAG scenario, document data is first converted into vector representations, mapping words, sentences, or documents into high-dimensional vector spaces, and these vector data are stored in the vector database. Facing massive text data, the vector database can store the corresponding vectors in an orderly manner and establish an effective indexing mechanism to facilitate subsequent fast lookup and matching, enabling the rapid localization of information relevant to the user's problem in the RAG application.

The vector database can find the text content corresponding to vectors with high similarity within a very short time, providing a key guarantee for RAG to accurately retrieve relevant knowledge from the knowledge base, thereby improving the quality and accuracy of generated answers. The vector database has four capabilities: multiple index types, support for billions of vectors, hybrid search, and cloud-native capabilities. Multiple index types provide flexibility to optimize searches based on different data characteristics and use cases. Billions of vectors handle large datasets. Hybrid search combines vector search with traditional keyword search to improve retrieval accuracy. Cloud-native capabilities ensure seamless integration, scalability, and management in cloud environments.

The graph database of the mineral knowledge graph is used for the overall planning of the prospecting prediction knowledge graph. First, entity types are determined, and core entities in the field of prospecting prediction are identified. For example, entity categories in the prospecting prediction knowledge graph include, but are not limited to: "ore deposit model," "prospecting prediction model," "metallogenic model," and "ore deposit geological characteristics." Clarifying core entities is the basis for subsequently constructing graph relations.

Second, relation types are defined. Various relationships between entities in the mineral knowledge graph are analyzed. For example, there is an "inclusion" relationship between "prediction elements" and "ore-controlling structures," "rock masses," and "gravity anomalies," and an "anomaly combination" relationship between "Au element anomaly" and "As element anomaly." Accurately and clearly defining these relationships can construct a complete knowledge network. Then, the schema layer is constructed, which describes the entities and relationships related to prospecting prediction in a structured manner, using graph models (such as RDF) or ontology languages for representation, equivalent to drawing a "blueprint" of the knowledge graph.

According to the entity types, relation types, and schema determined by the planning of the mineral knowledge graph, knowledge extraction is first performed, including entity extraction, relation extraction, and attribute extraction. Second, relation extraction is performed to conduct in-depth semantic analysis of the document data. Then, attribute extraction is performed to extract attributes related to entities, further enriching the connotation of the entities and making the knowledge in the mineral knowledge graph more complete and detailed. Finally, knowledge fusion is performed, including entity alignment and knowledge merging. Entity alignment ensures the uniqueness and accuracy of entities in the mineral knowledge graph. Knowledge merging is used to integrate knowledge extracted from different sources, removing duplicates and contradictions.

The constructed mineral knowledge graph is stored in the graph database. The graph database is based on graph theory and represents data as nodes (Node), edges (Edge), and the attributes (Property) they carry. Nodes are typically used to represent entities related to prospecting prediction, such as "ore deposit geological characteristics," "metallogenic model," "prediction elements," "ore-controlling structures," "rock masses," "gravity anomalies," and "magnetic anomalies." Edges are used to describe relationships between prospecting prediction entities, such as "parallel unconformity" relationships between "strata" and "primary- secondary" relationships between "faults."

In step S12, optimizing the extracted keywords to generate a prompt specifically includes:

S41: constructing a graph database query language and query statements, performing syntax checking on the keywords, and determining the specific graph structure and information the user wants to query;

S42: formulating a specific query execution plan based on the analysis of the graph structure and the query requirements, and determining the visitation order of nodes and relations;

S43: traversing the nodes and relations, organizing the qualified nodes, relations, and associated attribute information, and generating a prompt.

In the present embodiment, a large model is first used to construct the graph database query language and query statements. Second, the query statements are parsed for syntax checking to verify whether the statements conform to the syntax rules of the specified query language. Based on correct syntax, the semantics of the statements are further analyzed to determine the specific graph structure and information the user wants to query. The query execution path is then planned. Based on the analysis of the graph structure and the query requirements, a specific query execution plan is formulated to determine the order of visiting nodes and traversing relations. Then, the query operation is executed. According to the planned execution path, actual node and relation traversal operations are performed. The traversal process follows the set search strategy, traversing along the edges in the graph to find qualified nodes. Finally, the query results are returned. After completing the query operation, the qualified nodes, relations, and related attribute information are organized to generate a prompt. The prompt can be expressed in forms including, but not limited to, tables or JSON format.

S 13: constructing a mineral prospecting large model to reason about the prompt, expanding the prompt to obtain a complete statement that professionally reformulates the user's problem. The large model is incrementally trained based on a general large model to comprehensively improve language learning ability, summarization ability, text generation ability, and text embellishment ability, enabling the mineral prospecting large model to possess comprehensive research capabilities in the prospecting prediction business process.

In step S13, constructing the mineral prospecting large model specifically includes:

S51: cleaning the stored data, selecting a tokenization tool to perform tokenization on the cleaned data, expanding the vocabulary, and increasing sample diversity via text data augmentation techniques;

S52: dividing the processed data into a training set, a validation set, and a test set at a preset ratio, training, tuning, and evaluating a pre-trained mineral prospecting large model to obtain the mineral prospecting large model;

S53: adjusting the dimensions of the word embedding layer and the output layer of the mineral prospecting large model according to the expanded vocabulary to maintain consistency with the size of the expanded vocabulary;

S54: performing supervised fine-tuning, incremental training, and mineral- prospecting instruction learning on the mineral prospecting large model.

In the present embodiment, the mineral prospecting large model module utilizes an open-source general large model as the base LLM-3, such as Qwen72B or Llama3.2, which, after training on open datasets, acquires general knowledge generation capability. On the foundation of the general large model LLM-3 and based on the personal user workspace, prospecting datasets are appended to perform incremental pre-training, thereby obtaining a large model in the vertical domain of mineral resources-namely, the mineral prospecting large model. Specifically, this process includes: First, cleaning the appended prospecting datasets, including but not limited to document parsing, noise elimination, and removal of redundant and irrelevant content; Second, performing data processing-selecting a tokenization tool to conduct tokenization on the mineral prospecting knowledge text, and expanding the vocabulary to accommodate terminology specific to the prospecting prediction field; increasing sample diversity and enhancing the model's generalization ability through text data augmentation techniques such as synonym conversion, back-translation, random insertion, and random deletion of words; dividing the processed dataset into a training set, a validation set, and a test set, typically split at a preset ratio such as 8:1:1, for model training, tuning, and evaluation.

Next, model adjustment is performed. Model dimension adjustment involves re- adjusting the dimensions of the word embedding layer and the output layer of the large language model according to the size of the expanded vocabulary, so as to maintain consistency with the number of entries in the new vocabulary. Finally, incremental training is conducted. A training framework is selected based on computational resources and training requirements, and one of the following three training strategies is adopted: (1) Pre-training first with large- scale general corpora related to prospecting prediction, such as encyclopedias, books, reports, and papers, followed by secondary training with small-scale domain corpora authored by academicians, authoritative experts, and published monographs and papers in prospecting prediction; (2) Directly performing pre-training with large-scale domain corpora; (3) Simultaneously mixing general corpora and domain corpora at a certain ratio for training.

Prospecting-related question-answer pairs are added for instruction learning in prospecting, including but not limited to knowledge of metallogenic geological background, metallogenic regularities, geophysical characteristics, and geochemical characteristics. Supervised fine-tuning of the mineral prospecting large model is performed by first pre-training the large language model to obtain parameter results on the general dataset, and then adjusting the mineral prospecting large model on a labeled dataset for specific tasks using cross-entropy loss, so that the model parameters are adjusted from the initial parameters to minimize the loss function of the supervised task.

Instruction tuning of the mineral prospecting large model is performed by first collecting or constructing instances in an instruction format, where each instance in the instruction dataset consists of three elements: instruction, context (optional), and instruction- based input and output. Instructions include detailed information such as task name, description, points of attention, and positive/negative examples, and are obtained either by manual integration/conversion or by generation using a large language model, yielding a dataset in the "instruction, output" format. Then, the LLM is adjusted in a supervised manner. Once a general instruction dataset is obtained, it can be used to adjust the pre-trained mineral prospecting large model. After instruction tuning, the mineral prospecting large model exhibits excellent generalization to unseen tasks. Instruction tuning stimulates the language model's comprehension ability, makes fuller use of prior knowledge, and enables the model to understand and respond correctly given clearer instructions, thus generalizing to multiple tasks.

Preference pairs for prospecting are incorporated into the mineral prospecting large model to enable learning based on prospecting experts' preferences, addressing risks that the generated content may be inaccurate, misleading, or even contain harmful information, and ensuring that the large language model's behavior aligns with human values. Human preference alignment adjusts and optimizes the decision-making process of the large language model to ensure that its outputs are not only accurate but also follow ethical norms, are unbiased, and reflect socially recognized values and ethical standards. The goal of alignment is to create a model that both understands and generates human language and demonstrates attention to fairness, transparency, and responsibility in its decisions, thereby reducing potential negative impacts. The mineral prospecting large model adopts a Reinforcement Learning from Human Feedback (RLHF) approach, including pre-training and supervised fine-tuning of the model, training a reward model, and adjusting the model using reinforcement learning.

First, starting from supervised fine-tuning, a supervised learning method is used to adjust the mineral prospecting large model on an annotator, collecting a supervised dataset containing input prompts (instructions) and desired outputs, i.e., prospecting prediction knowledge preference pairs, to adjust the model. These prospecting prediction knowledge preference pairs are created by human annotators for certain specific tasks while ensuring task diversity. Second, the reward model is trained using human feedback obtained from the annotator. The annotator ranks the reward model's outputs based on their consistency with expected behaviors. Specifically, sampled prompts (from the supervised dataset or human- generated prompts) are fed into the reward model to generate a certain number of output texts, and human annotators label preferences for these input-output pairs. Then, the reward model is trained to predict human-preferred outputs.

Finally, a reinforcement learning algorithm is employed in conjunction with the trained reward model. In the reinforcement learning problem, the policy is provided by the pre- trained mineral prospecting large model; the action space corresponds to the vocabulary of the language model; the state is the currently generated token sequence; and the reward is supplied by the reward model. To prevent the mineral prospecting large model from deviating significantly from the initial (pre-adjustment) model, a penalty term is typically incorporated into the reward function, and multiple iterations are performed to achieve better alignment of the mineral prospecting large model. The Proximal Policy Optimization (PPO) algorithm is used to further adjust the mineral prospecting large model based on received human feedback, thereby making the model more consistent with human preferences and improving its instruction-following capability.

To guide the mineral prospecting large model in performing complex reasoning, the model employs prompt engineering to provide guidance and optimization, thereby extending its capabilities and broadening the range of tasks it can effectively execute. For any input prompt, the mineral prospecting large model generates a corresponding output answer. A prompt includes three main content types: input, context, and examples. The input specifies the information for which the model is required to generate a response; context and examples are optional components of the prompt-the context provides explanations regarding the model's behavior, and examples are input-output pairs within the prompt that demonstrate the expected response.

S14: performing multi-task decomposition on the complete statement to obtain a plurality of subtasks, and scheduling the plurality of subtasks to corresponding agents via the graph database of the mineral knowledge graph for stepwise prediction.

In the present embodiment, the complete statement (i.e., a complex prospecting prediction task) is decomposed into a plurality of subtasks, and the workflow subtasks of prospecting prediction are scheduled to corresponding agents to achieve the final prospecting prediction objective. An agent may generate a plan without adjustment through different reasoning strategies, or adjust the generated plan based on external feedback. the present disclosure performs multi-task decomposition of the complete statement into a plurality of subtasks and strategically assigns corresponding agents to ensure seamless execution of the planned prospecting prediction workflow.

The prospecting prediction multi-agent system (hereinafter referred to as "agents") possesses highly intelligent comprehension and generation capabilities and constitutes intelligent computing entities of prospecting prediction microservice components capable of accurately perceiving the environment, making decisions, and executing actions, thereby accomplishing specific tasks in the prospecting prediction business process such as data querying, data mining, and information extraction.

First, historical thoughts, actions, and environmental observations generated during agent execution are recorded. For example, the agent may retain a memory of the user reading geophysical, geochemical, and remote sensing data from the database, using geophysical processing and analysis tools, geochemical processing and analysis tools, and subsequently using the mineral prospecting large model to select prediction elements. Based on accumulated diverse prospecting prediction memories, the agent can revisit and utilize previous records and experiences to more effectively handle more complex prospecting prediction tasks.

Agent memory may be categorized according to duration into short-term memory and long-term memory. Short-term memory is integrated into the agent to enhance its ability to maintain the trajectory of the currently ongoing prospecting prediction task and is frequently used in multi-turn interactions. Long-term memory is used to retain valuable experience from historical prospecting prediction tasks and is recalled by the agent when solving unseen tasks. Due to the extensive nature of such trajectories, long-term memory typically employs distillation techniques or stores only key information. Second, information is received from the prospecting prediction workspace environment. The prospecting prediction agent can perceive multimodal inputs, such as text input, visual input, and auditory input. Historical prospecting prediction data are stored in text form, and prospecting prediction text can flexibly express intentions, information, and knowledge.

Third, the agent interacts with and influences the external environment. An important mechanism is the control and utilization of external prospecting prediction microservice algorithmic tools, extending the inherent functionality of the LLM by accessing more external resources and expanding the operational space beyond mere text interaction. The prospecting prediction multi-agent system includes a decision support agent, a target area optimization agent, a prospecting prediction agent, an information extraction agent, a big data agent, a GIS tool agent, a mathematical geology agent, a geostatistics agent, a classical prediction agent, a machine learning agent, and a deep learning agent. Each agent automatically schedules and executes backend microservices when performing tasks to accomplish corresponding subtasks. All microservices interface with geological, geophysical, geochemical, and remote sensing databases, enabling bidirectional interconnection, dynamic access, and storage of source data, information extraction data, prospecting prediction data, target area optimization data, and decision support data for prospecting prediction tasks.

The decision support agent is responsible for integrating, analyzing, and processing information from various data sources to provide users with intelligent support and recommendations. By considering multiple factors, it estimates the potential value of target areas and provides a scientific basis for users, including historical exploration data, market demand, environmental impact, and economic feasibility. Through machine learning techniques, it continuously feeds back and improves the decision model, and its adaptive characteristics enable the decision support agent to maintain efficient and effective decision- making capabilities under changing environments and highly uncertain geological conditions.

The target area optimization agent identifies blocks with exploration value from massive geological data, including comprehensive analysis of geological, geophysical, geochemical, and remote sensing information. Simultaneously, the target area optimization agent performs risk assessment and economic feasibility analysis, taking into account factors such as the potential value of mineral deposits, extraction costs, environmental impact, and legal restrictions, so as to ensure maximum reduction of environmental impact and compliance with the principles of sustainable development. The target area optimization agent relies not only on historical data and expert experience but also incorporates dynamic data, and possesses real-time updating and feedback functions. When new geological survey data or market dynamics emerge, the target area optimization agent can rapidly integrate such information into its optimization model and promptly adjust target area recommendation results.

The prospecting prediction agent employs various algorithms and technical means to help more accurately locate possible positions of mineral resources and delineate prospective and target areas for prospecting prediction. Positioning prediction agents in mineral resource prediction include following agents.

Information quantity method prospecting prediction agent: Based on information quantity theory, it analyzes correlations between numerous geological factors and known mineral distribution. By calculating the amount of information carried by each factor, it measures its contribution to mineralization. Integrating these pieces of information allows the agent to assess the mineralization potential of different segments within the study area, thereby delineating regions with higher prospecting potential and providing focused guidance for subsequent exploration.

Weights-of-evidence method prospecting prediction agent: Based on Bayesian theory, it treats various metallogenic-related geological evidences as independent "evidence layers." It first determines the weight of each evidence layer's effect on mineralization, including stratigraphic lithology, structural characteristics, geochemical anomalies, and other evidence factors. After complex statistical analysis, it obtains respective weight values reflecting their influence on mineralization, and then uses these weights to comprehensively evaluate the mineralization probability of different regions, making predictions for favorable mineralization zones. This provides a more scientific basis for prospecting prediction and improves accuracy.

Feature analysis method prospecting prediction agent: Focuses on various characteristics of geological bodies, collecting data such as rock mineral composition, structural features, and geophysical field characteristics. It conducts in-depth mining and analysis of these features to identify feature combinations closely related to mineralization. By establishing a feature model, the agent can recognize regions possibly containing minerals based on the characteristics exhibited by geological bodies in the study area, helping explorers narrow the prospecting scope and focus on zones with the highest mineralization potential.

Random forest method prospecting prediction agent is based on an ensemble learning algorithm composed of multiple decision trees. The corresponding prospecting prediction agent leverages this advantage to operate by taking large volumes of geological data as input, including geological structures, geochemical data, and geophysical data. Each decision tree grows based on a subset of the data and random features, and makes mineralization prediction judgments. The results from numerous decision trees are aggregated, and mechanisms such as voting are used to determine the final mineralization prediction outcome. In this way, the error of a single model is effectively reduced, enhancing prediction reliability and stability, and enabling the agent to perform well even under complex geological conditions.

Support vector machine method prospecting prediction agent excels at handling classification and regression problems. In mineral prediction, the agent maps geological characteristic data and other data into a high-dimensional space, seeking an optimal classification hyperplane to distinguish between mineralized and non-mineralized areas. It handles nonlinear relationships in data effectively, and even with complex variable relationships in geological data, it can accurately uncover latent mineralization patterns, thereby enabling precise predictions of whether minerals exist in different regions and providing strong decision support for mineral exploration.

Convolutional neural network method prospecting prediction agent possesses powerful automatic feature extraction capabilities. Utilizing CNN, the agent processes geological data, geophysical data, and geochemical data, and can automatically capture features such as stratigraphic texture and anomaly morphology contained therein. Through successive convolution, pooling, and other operations, it continuously refines key information, and judges the likelihood of mineralization based on these features, demonstrating unique advantages and opening new perspectives for prospecting work.

Graph neural network method prospecting prediction agent is developed in response to the existence of numerous complex network relationships in geological phenomena, such as graphically structured geological formations and spatial associations of mineralized alterations. This agent constructs graph-structured data from geological entities and their relationships, and through information transmission and updating of nodes and edges, mines hidden mineralization information. It can accurately grasp mineralization patterns under complex geological relationships and effectively predict regions with mineralization potential, meeting modern geological research needs for complex relational analysis.

Adversarial neural network method prospecting prediction agent leverages a generative adversarial architecture including a generator and a discriminator that are mutually adversarial yet collaborative. The generator produces geological data distributions resembling mineralization patterns, while the discriminator assesses their authenticity. Through continuous adversarial (game-theoretic interaction), the generator's outputs progressively approximate realistic mineralization scenarios. This approach can simulate more potential mineral-bearing units, assisting users in analyzing mineralization possibilities in the study area from multiple angles more comprehensively. These diverse agents, based on their respective principles and methods, complement and collaborate with one another, jointly providing diversified technical support for the complex and important task of mineral resource prediction, thereby improving the efficiency and success rate of prospecting prediction.

The information extraction agent is one of the key components in the prospecting prediction multi-agent system, responsible for extracting valuable information from various data sources. The information extraction agent typically works in close collaboration with other agents, delivering extracted information to the prospecting prediction agent, target area optimization agent, and decision support agent via APIs or microservices. This interconnected mechanism ensures the flow and sharing of information, forming an efficiently coordinated working unit for the entire prospecting prediction system.

The big data agent is responsible for managing and analyzing massive exploration data, extracting trends and patterns to provide support for other agents. The GIS tool agent utilizes geographic information system technology to analyze spatial data, helping agents understand the relationship between geographical environments and prospecting prediction, thereby supporting other agents.

The mathematical geology agent applies mathematical models to explain mineral deposit distribution phenomena, helps predict the geological structures where mineral deposits are located, and provides support for other agents. The geostatistics agent is responsible for applying statistical methods to analyze sample data, assess confidence levels and geological uncertainty, and provide support for other agents.

The geostatistics agent is responsible for applying statistical methods to analyze sample data, assess confidence levels and geological uncertainty, and provide support for other agents.

The classical prediction agent utilizes traditional geological prediction methods for preliminary evaluation, compares and calibrates calculation results with those of other agents, and provides support for other agents.

The machine learning agent leverages machine learning techniques to automatically learn patterns from data, providing additional basis for decision support and providing support for other agents.

The deep learning agent is a further development of machine learning, processing more complex sample data through neural network models to improve prediction accuracy and provide support for other agents.

Step S14 further includes:

performing semantic understanding on the complete statement using natural language processing (NLP) techniques to extract key information and perform task decomposition, while establishing, for each agent, a semantic label library of algorithms, and intelligently selecting and orchestrating algorithms based on a matching degree between task semantics and algorithm semantic labels to match tasks with algorithms;

Constructing a dynamic Bayesian network with the geological characteristics of the prospecting area, data quality, and computing resources as nodes, and dependencies among the factors as edges, and dynamically adjusting algorithm selection and execution order by updating node information and edge weights in real time;

Exploring an optimal collaboration policy among agents via reinforcement learning, maintaining real-time communication among agents, and adjusting the collaboration policy among agents according to a global reward signal;

Recording the execution process and results of the algorithms, and providing a reward to agents corresponding to algorithms whose collaboration degree reaches a preset threshold during collaboration;

Monitoring, in real time, the computing resource usage of each agent, and dynamically adjusting the execution order of algorithms and allocating resources to the algorithms according to remaining resources and the resource demands of the algorithms.

Performing semantic understanding on the complete statement using NLP techniques to extract key information specifically includes:

S61: recognizing words in the complete statement and semantic roles among the words, and analyzing dependency relations among the words in the complete statement;

S62: capturing sentence structure and sequential information in the complete statement via a BiLSTM to extract contextual semantic features from the complete statement;

S63: extracting key information in the complete statement by combining the dependency relations among words obtained in step S61 and the contextual semantic features extracted in step S62 with the graph database of the mineral knowledge graph.

In the present embodiment, analyzing dependency relations among words in the complete statement refers to determining grammatical structural relationships between words in the sentence. Dependency relations reflect "governing" and "subordinate" relationships among words and are used to understand the sentence's grammatical structure. The output of dependency relation analysis is a dependency tree, where each word has a pointer to its governing word. For example, identifying entities in a report (e.g., ore body, ore grade) and their relations (e.g., ore body located in ...). Extracting contextual semantic features considers the specific meaning of words in context, focusing on semantic roles, semantic associations, and overall sentence semantics. The output of contextual semantic feature extraction is a semantic representation of words or the semantic structure of the sentence. Combining dependency relations and contextual semantic features with the mineral knowledge graph enhances semantic understanding using background knowledge in the graph to extract key information from the complete statement, such as attributes of mineral types, types of geological structures, and exploration methods.

Exploring an optimal collaboration policy among agents via reinforcement learning specifically includes:

S71: defining a local state of each agent, a global environment, and a global reward signal;

S72: enabling all agents to interact with observations of their local states and the gl obal environment to obtain, for the current agent, observations that incorporate observations from other agents;

S73: processing observations of different dimensions via semantic embedding to convert the observations into Q (Query), K (Key), and V (Value) sequences, learning features of the Q, K, and V sequences and their interrelationships via a self-attention mechanism, and fusing the sequences via a Transformer architecture to generate a globally optimized hidden state;

S74: generating, via a multilayer perceptron (MLP), a local Q-value for each agent based on the fused hidden state, and combining the local Q-values of all agents into a global Q-value via a value decomposition method;

S75: updating a policy network of each agent via a reinforcement learning algorithm using the global Q-value and the global reward signal;

In the present embodiment, in a multi-agent system, each agent's observations are typically local, whereas global information is crucial for optimizing collaboration policies. Via the self-attention mechanism, the current agent's observations can interact with those of other agents. Reinforcement learning optimizes agents' collaboration policies through a global reward signal, enabling agents to better understand the global environment and make superior collaborative decisions. Observations of each agent come from different dimensions, e.g., position, velocity, status. To enable effective processing of such information in the self- attention mechanism, they are first mapped into a unified vector space via semantic embedding. They are then transformed into Q, K, V sequences. The self-attention mechanism learns their features and interrelationships, facilitating information exchange among agents and enhancing global perception. The Q, K, V sequences after self-attention processing contain both the current agent's local observations and observations from other agents. For example, by calculating similarities between Query and Key and using these similarities to compute weighted sums of Value, the mechanism learns the features and interrelations of these sequences, strengthening the agent's perception of the global environment.

S15: integrating and feeding back the prediction results of the agents to the user, specifically includes:

integrating the prediction results of the agents and feeding the results back to the user in the form of text, images, GIS maps, three-dimensional models, and document reports.

In the present embodiment, a multimodal data fusion and intelligent generation technology is first proposed, including cross-modal information integration and conversion technology, achieving deep fusion of multimodal data such as text, images, GIS maps, three- dimensional geological models, and document reports. It enables the system to generate comprehensive and intuitive answers by integrating information obtained from different data sources. For example, when processing the problem "delineate metallogenic prospective areas," the system can not only extract relevant theories and methods from text but also combine geographic information from GIS maps and the spatial morphology of ore bodies shown in three-dimensional models, thereby generating a comprehensive and intuitive answer. At the same time, it possesses cross-modal conversion capability, being able to transform text information into images, GIS maps, or three-dimensional models, so as to meet users' diverse needs and modes of understanding.

Second, a deep learning-based multimodal generation model is proposed, utilizing technologies such as Transformer and GAN, and trained according to the characteristics of different modal data. For text-type answers, the model can generate logically clear and content- accurate textual expressions based on the problem and retrieved knowledge; for geological maps and three-dimensional models, the model can automatically generate high-quality maps and models based on input geological data and analysis results. For example, when generating a three-dimensional model of an ore deposit, the model can accurately construct the ore body's three-dimensional shape and internal structure based on multi-source data such as geophysical and geochemical data, and can update and optimize the model in real time to reflect the latest prospecting information.

Third, an intelligent document report generation technology is proposed, including report content generation based on the mineral knowledge graph and the large model. The mineral prospecting large model automatically extracts relevant information based on the problem and analysis results and organizes it into logically clear, content-complete report text. For example, when preparing a mineral potential evaluation report, the system can acquire knowledge such as metallogenic geological background and mineral resource characteristics from the mineral knowledge graph, combine it with prospecting prediction analysis results, and automatically generate the various chapters of the report in accordance with geological survey report writing specifications.

Finally, a personalized report customization and optimization technology is proposed. Users can select the content, format, focus, etc., of the report according to their own needs and preferences, and the system automatically adjusts the report generation strategy to produce reports meeting user requirements. At the same time, it features report optimization functions, enabling grammar checking, logic verification, content refinement, and other operations on the generated report to ensure the report's accuracy and professionalism.

The foregoing descriptions are merely preferred embodiments of the present disclosure and are not intended to limit the invention. Any modifications, equivalent substitutions, improvements, etc., made within the spirit and principle of the present disclosure shall fall within the protection scope of the present disclosure.

What is claimed is:

1. A mineral prospecting prediction method based on multi-agent technology, comprising:
S11: performing keyword extraction on a mineral-related problem input by a user;
S12: establishing a vector database of mineral knowledge texts and a graph database of a mineral knowledge graph, and optimizing the extracted keywords to generate a prompt;wherein establishing the vector database of mineral knowledge texts and the graph database of the mineral knowledge graph specifically comprises:S31: collecting and storing documents in real time, comprising prospecting prediction papers, monographs, and geological reports;S32: performing unified format conversion and preprocessing on the stored document data;S33: segmenting the preprocessed document data into chunks of a preset length, inputting the chunks into an embedding model to convert the document data into vectors, and constructing the vector database of mineral knowledge texts;S34: performing knowledge extraction, relation extraction, and attribute extraction on the chunked document data, fusing the extracted data, and constructing the graph database of the mineral knowledge graph;optimizing the extracted keywords to generate a prompt specifically comprises:S41: constructing a graph database query language and query statements, performing syntax checking on the keywords, and determining a specific graph structure and information the user wants to query;S42: formulating a specific query execution plan based on the analysis of the graph structure and the query requirements, and determining the visitation order of nodes and relations;S43: traversing the nodes and relations, organizing the qualified nodes, relations, andassociated attribute information, and generating the prompt;
S13: constructing a mineral prospecting large model to reason about the prompt, expanding the prompt to obtain a complete statement that professionally reformulates the user's problem;
S14: performing multi-task decomposition on the complete statement to obtain a plurality of subtasks, and scheduling the plurality of subtasks to corresponding agents via the graph database of the mineral knowledge graph for stepwise prediction;wherein step S14 further comprises:performing semantic understanding on the complete statement using natural language processing (NLP) techniques to extract key information and perform task decomposition, while establishing, for each agent, a semantic label library of algorithms, and intelligently selecting and orchestrating algorithms based on a matching degree between task semantics and algorithm semantic labels to match tasks with algorithms;constructing a dynamic Bayesian network with the geological characteristics of the prospecting area, data quality, and computing resources as nodes, and dependencies among the factors as edges, and dynamically adjusting algorithm selection and execution order by updating node information and edge weights in real time;exploring an optimal collaboration policy among agents via reinforcement learning, maintaining real-time communication among agents, and adjusting the collaboration policy among agents according to a global reward signal;recording the execution process and results of the algorithms, and providing a reward to agents corresponding to algorithms whose collaboration degree reaches a preset threshold during collaboration;monitoring, in real time, the computing resource usage of each agent, and dynamically adjusting the execution order of algorithms and allocating resources to the algorithms according to remaining resources and the resource demands of the algorithms;wherein performing semantic understanding on the complete statement using NLP techniques to extract key information specifically comprises:S61: recognizing words in the complete statement and semantic roles among the words, and analyzing dependency relations among the words in the complete statement;
S62: capturing sentence structure and sequential information in the complete statement via a BiLSTM to extract contextual semantic features from the complete statement;
S63: extracting key information in the complete statement by combining the dependency relations among words obtained in step S61 and the contextual semantic features extracted in step S62 with the graph database of the mineral knowledge graph;
exploring an optimal collaboration policy among agents via reinforcement learning specifically comprises:S71: defining a local state of each agent, a global environment, and a global reward signal;S72: enabling all agents to interact with observations of their local states and the global environment to obtain, for the current agent, observations that incorporate observations from other agents;S73: processing observations of different dimensions via semantic embedding to convert the observations into Q (Query), K (Key), and V (Value) sequences, learning features of the Q, K, and V sequences and their interrelationships via a self-attention mechanism, and fusing the sequences via a Transformer architecture to generate a globally optimized hidden state;S74: generating, via a multilayer perceptron (MLP), a local Q-value for each agent based on the fused hidden state, and combining the local Q- values of all agents into a global Q-value via a value decomposition method;S75: updating a policy network of each agent via a reinforcement learning algorithm using the global Q-value and the global reward signal;
S15: integrating and feeding back the prediction results of the agents to the user.

2. The mineral prospecting prediction method based on multi-agent technology according to claim 1, wherein step S11 comprises:
S21: parsing the mineral-related problem using NLP techniques and matching and classifying the parsed problem with nodes and relations in the mineral knowledge graph;
S22: automatically generating keywords corresponding to the mineral-related problem by combining the mineral knowledge graph and historical question data.

3. The mineral prospecting prediction method based on multi-agent technology according to claim 1, wherein constructing a mineral prospecting large model of step S13 comprises:
S51: cleaning the stored data, selecting a tokenization tool to perform tokenization on the cleaned data, expanding a vocabulary, and increasing sample diversity via text data augmentation techniques;
S52: dividing the processed data into a training set, a validation set, and a test set at a preset ratio, training, tuning, and evaluating a pre-trained mineral prospecting large model to obtain the mineral prospecting large model;
S53: adjusting dimensions of an embedding layer and an output layer of the mineral prospecting large model according to the expanded vocabulary to maintain consistency with a size of the expanded vocabulary;
S54: performing supervised fine-tuning, incremental training, and mineral-prospecting instruction learning on the mineral prospecting large model.

4. The mineral prospecting prediction method based on multi-agent technology according to claim 1, wherein step S15 comprises:
integrating the prediction results of the agents and feeding the results back to the user in the form of text, images, GIS maps, three-dimensional models, and document reports.
